(19) United States
(12) Patent Application Publication
(10) Pub. No.: US 2011/0082239 A1
(43) Pub. Date: Apr. 7, 2011

(54) THERMOSETTING EPOXY COMPOSITION WITH LOW EXPANSIBILITY

(75) Inventor: Ming-Jen TZOU, Taipei (TW)

(73) Assignee: NAN YA PLASTICS CORPORATION, Taipei (TW)

(21) Appl. No.: 12/892,990

(22) Filed: Sep. 29, 2010

(30) Foreign Application Priority Data
Oct. 2, 2009 (TW) 098133507

(51) Int. Cl. C08K 3/36; C08K 3/38; C08K 3/22

(52) U.S. Cl. 523/443; 523/466; 523/445; 523/457

(57) ABSTRACT

A thermosetting epoxy composition contains a modified silicon dioxide and is suitable for use in preparing an epoxy laminate having a low coefficient of thermal expansion and good drilling workability, which modified silicon dioxide contains no crystal water, has low expansibility, and contains 40% to 80% by weight of silicon dioxide and 60% to 20% by weight of an inorganic additive, and the modified silicon dioxide is obtained by a high-temperature (above 1000° C.) sintering process followed by a crushing process.

### BACKGROUND OF THE INVENTION

1. Field of the Invention

The present invention relates to a modified silicon dioxide and, more particularly, to a thermosetting epoxy composition which contains such a modified silicon dioxide and is suitable for use in preparing an epoxy laminate having a low coefficient of thermal expansion and good drilling workability.

2. Description of the Prior Art

Two important directives of the European Union, namely the Waste Electrical and Electronic Equipment (WEEE) Directive and the Restriction of Hazardous Substances (RoHS) Directive, came into force on Jul. 1, 2006. According to these directives, hazardous substances such as those containing Pb, Cd, Hg, Cr⁶⁺, PBB, and PBDE are prohibited from being used in electric and electronic products. In particular, the ban on the use of lead will bring the global electronic industry into a lead-free era.

Tin-lead alloys have a melting point around 183° C., which is the lowest of all alloys for industrial uses. When lead-free manufacturing processes are adopted, the melting points of those otherwise lead-containing alloys will increase by at least 20° C. As a result, the reflow temperature of lead-free manufacturing processes will rise to 265° C. or even higher.

As higher process temperatures are demanded, and in order to minimize dimensional variation of epoxy laminates under high temperature, it is common practice to add a certain amount of inorganic filler material, such as aluminum hydroxide (Al(OH)₃) or silicon dioxide (SiO₂), into the epoxy formulas.

Aluminum hydroxide contains crystal water, whose cracking temperature is as low as 250° C. to 270° C. Therefore, when natural aluminum hydroxide is used as the filler material of epoxy laminates, the crystal water in the aluminum hydroxide will crack, turn into vapor, and then dissipate during a high-temperature manufacturing process or a heat resistance test. The dissipating vapor and its vapor pressure tend to result in delamination and bursting of the epoxy laminates.

Silicon dioxide, on the other hand, has high thermostability but is too hard, with a Mohs hardness up to 7 to 7.5. When natural silicon dioxide is used as the filler material of epoxy laminates, the excessively high hardness of silicon dioxide makes drilling difficult. Moreover, epoxy laminates added with silicon dioxide are brittle and therefore do not guarantee reliable use. For instance, when an epoxy laminate containing silicon dioxide is drilled, the drilling bit may undergo undue wear, and the drilling quality is likely to be poor. Even if the epoxy laminate is electroplated before drilling, the bore wall tends to be of low quality and may lead to abnormal electric properties of the resultant printed circuit boards.

### SUMMARY OF THE INVENTION

The primary objective of the present invention is to provide a modified silicon dioxide which contains no crystal water, has low expansibility, and can be used to enhance the drilling workability of epoxy laminates or printed circuit boards. The modified silicon dioxide contains 40% to 80% by weight of silicon dioxide and 60% to 20% by weight of an inorganic additive, wherein the inorganic additive is one or more selected from the group consisting of aluminum oxide (Al₂O₃), boron trioxide (B₂O₃), calcium oxide (CaO), and magnesium oxide (MgO); and the modified silicon dioxide is prepared by sintering the mixture at a temperature higher than 1000° C. and then crushing the sintered product. The silicon dioxide has an average particle size ranging from 0.1 to 20 μm, and preferably from 0.5 to 5.0 μm.

### DETAILED DESCRIPTION OF THE INVENTION

As printed circuit boards have more and more layers and are required to be lead-free, stricter requirements are imposed on the thermal expansion coefficients and heat resistance of copper foil laminates. In order to ensure that the traces of a printed circuit board will not break or even short-circuit in a high-temperature manufacturing process due to thermal expansion of the copper foil laminate, the coefficient of thermal expansion of the copper foil laminate must be low.

The present invention discloses a modified silicon dioxide which contains no crystal water, has low expansibility, and is useful in increasing the drilling workability of printed circuit boards. The modified silicon dioxide contains 40% to 80% by weight of silicon dioxide mixed with 60% to 20% by weight of an inorganic additive and is obtained by a high-temperature (above 1000° C.) sintering process followed by a crushing process. The average particle size of the silicon dioxide is between 0.1 and 20 μm, and preferably between 0.5 and 5.0 μm. The inorganic additive is one or more minerals selected from the group consisting of aluminum oxide (Al₂O₃), boron trioxide (B₂O₃), calcium oxide (CaO), and magnesium oxide (MgO).

The mixing proportion of silicon dioxide in the modified silicon dioxide may also be 5% to 40% by weight, or 80% to 99% by weight. However, if the modified silicon dioxide has an excessively low mixing proportion of silicon dioxide and is used in an epoxy laminate or prepreg, the thermal expansion coefficient of the epoxy laminate or prepreg will not be effectively lowered, and the finished product may have poor thermostability. On the other hand, if the mixing proportion of silicon dioxide in the modified silicon dioxide is too high, the drilling workability of the resultant epoxy laminate will not be significantly improved owing to the high hardness. Hence, the modified silicon dioxide of the present invention preferably contains 40% to 80% by weight of silicon dioxide.

If the silicon dioxide used in the modified silicon dioxide of the present invention has a particle size smaller than 0.1 μm, the large surface area of the silicon dioxide will result in considerably high viscosity, which in turn substantially increases the viscosity of a varnish already prepared and consequently makes the impregnation process difficult to perform. Therefore, when the modified silicon dioxide of the present invention contains relatively fine silicon dioxide particles, the mixing proportion of the silicon dioxide should be lowered.

Furthermore, in view of the trend that electronic products are made increasingly thinner and lighter, the thicknesses of epoxy laminates and prepregs will have to be reduced to 30 to 50 μm. If silicon dioxide with a particle size larger than 20 μm is used, the varnish resin used in preparing the epoxy laminates and pre-pregs cannot cover the silicon dioxide completely. Therefore, the modified silicon dioxide of the present invention preferably contains silicon dioxide whose particle size ranges from 0.1 to 20 μm, and more preferably from 0.5 to 5.0 μm.

The modified silicon dioxide of the present invention contains no crystal water, and hence the heat resistance of the finished product will not be compromised by the otherwise potential release of crystal water during a high-temperature manufacturing process. Moreover, the modified silicon dioxide has a lower thermal expansion coefficient than natural silicon dioxide. The natural silicon dioxide has a specific gravity of 2.65 and a thermal expansion coefficient of 5.0 ppm/° C. By contrast, the modified silicon dioxide of the present invention has a lower specific gravity of 2.3 to 2.5 and a lower thermal expansion coefficient of 3 to 5 ppm/° C., thanks to the one or more minerals mixed with the modified silicon dioxide.

In addition, natural silicon dioxide is in a crystalline form. When heated at a high temperature above 1000° C. and then instantly cooled, crystalline silicon dioxide is turned into amorphous silicon dioxide, and its Mohs hardness is reduced from 7-7.5 to 6-6.5.

The modified silicon dioxide of the present invention is amorphous silicon dioxide and is added with one or more other minerals before being sintered. Therefore, the Mohs hardness of the modified silicon dioxde of the present invention can be further reduced to 4˜6, thereby effectively improving the drilling workability of printed circuit boards containing the modified silicon dioxide.

The modified silicon dioxide of the present invention may be surface-treated by a silane surface treatment agent to increase the adding amount and dispersion of the modified silicon dioxide.

The present invention also discloses a thermosetting epoxy composition containing the modified silicon dioxide of the present invention. The thermosetting epoxy composition can be used to prepare a varnish resin composition for making an epoxy laminate with a low coefficient of thermal expansion, thereby improving the drilling workability of epoxy laminates or printed circuit boards in general. The thermosetting epoxy composition has the following essential ingredients:
(a) a novolac epoxy, which is present in a proportion of 0 to 100 PHR of the entire solid content of the epoxy composition and has an epoxide equivalent weight (EEW) of about 160 to 250 g/eq;
(b) an epoxy, which is present in a proportion of 0 to 100 PHR of the entire solid content of the epoxy composition and has an epoxide equivalent weight of about 300 to 460 g/eq;
(c) a hardener, such as a novolac hardener or a dicyandiamide hardener, which is present in a proportion of 4.47 to 48 PHR of the entire solid content of the epoxy composition; and
(d) the foregoing modified silicon dioxide, which is present in a proportion of 13.4 to 181.5 PHR of the entire solid content of the epoxy composition.

The proportion of the modified silicon dioxide in the solid content of a varnish resin composition prepared therefrom ranges from 13.4 PHR (10% by weight) to 181.5 PHR (60% by weight). However, when dispersion and the thermal expansion coefficient lowering effect are taken into consideration, the proportion of the modified silicon dioxide is preferably between 30.3 PHR (20% by weight) and 121 PHR (50% by weight). When the modified silicon dioxide is added in a small proportion, the extent to which the thermal expansion coefficient can be lowered is small; when the modified silicon dioxide is added in a large proportion, the thermal expansion coefficient in the Z-direction can be substantially reduced, though with negative effects on dispersion and drilling workability. Therefore, the mixing proportion of the modified silicon dioxide can be adjusted according to the end uses of different printed circuit boards.

### Embodiments

The present invention is described in detail hereinafter by reference to the preferred embodiments. The ingredients, as well as their codes, used in the following embodiments and comparative examples are explained below:

Epoxy A: a novolac epoxy produced by Nan Ya Plastics Corporation, with the product code NPPN-431A70 and an epoxide equivalent weight ranging from 160 to 250 g/eq.

Epoxy B: an epoxy produced by Nan Ya Plastics Corporation, with the product code NPEB-454A80 and an epoxide equivalent weight ranging from 300 to 460 g/eq.

Hardener A: a novolac resin hardener produced by Nan Ya Plastics Corporation, with the product code NPEH710.

Hardener B: dicyandiamide.

Promoter 2M1: 2-Methylimidazole, 14.2%, dissolved in dimethylformamide (DMF).

Filler material A: natural silicon dioxide produced by Sibelco Bao-Lin, with the product code 925.

Filler material B: aluminum hydroxide produced by Showa Denko K.K., with the product code H42M.

The laminates in the examples and the comparative examples are measured by the methods described below, to determine their coefficients of thermal expansion, solder heat resistance at 288° C., drilling workability, and the dispersion of ingredients.

### 1. Coefficient of Thermal Expansion:

Laminate samples are etched to remove their copper foils and then diamond-cut into the dimensions of 4(length)×4(width)×0.8(thickness) mm. The coefficients of thermal expansion of the laminate samples are measured by thermomechanical analysis (TMA).

### 2. Solder Heat Resistance at 288° C.:

Laminates under test are treated in a pressure cooker (121° C., 2 atm) for ½ hour and then submerged in a 288° C. soldering pot. The time it takes for the laminates to delaminate and burst is recorded.

### 3. Drilling Workability:

Three laminates are stacked up and drilled as a unit by a drilling machine. Two thousand bores are drilled in each unit, with the bore diameter being 0.25 mm. Then, the precision of bore positions is measured as Cpk values and compared.

### 4. Dispersion of Ingredients:

After the copper foils of a laminate are removed by etching, the color on the outside of the laminate is examined by visual observation, so as to determine whether or not the color is uniform. Non-uniformity of color indicates poor dispersion of ingredients.

### Examples 1 to 8

In the examples 1 to 8, the proportions of epoxy A, epoxy B, hardener A or B, and promoter 2MI were the same, but the modified silicon dioxide (Sibelco Bao-Lin, product code G2C) was added in different proportions. Please refer to Table 1 for the detailed formulas. Besides, acetone was added such that the resultant varnish resin composition had a solid content of 75%.

Epoxy laminates were prepared using the conventional techniques. More specifically, 7628 fiberglass fabric was impregnated with the aforesaid varnish resin liquid and dried at 170° C. (temperature of the impregnating machine) for a few minutes. The drying time was adjusted and controlled such that the dried prepregs had a melting point viscosity ranging from 4000 to 10000 poise. Then, four such prepregs were stacked up and sandwiched between two 35 μm thick copper foils. The stacked semi-product was hot-pressed at a pressure of 25 kg/cm², with the heating-up time and the temperature under control. Thus, a laminate having a thickness of 0.8 mm was formed.

### Comparative Examples 1 and 2

The formulas of the comparative examples 1 and 2 are also shown in Table 1. More particularly, the proportions of epoxy A, epoxy B, hardener A, and promoter 2MI were the same, but filler materials A and B were added to the varnish resin compositions of the comparative examples 1 and 2, respectively, in the same proportion of 121 PHR (50% by weight). Also, acetone was added such that the varnish resin composition had a solid content of 75%. Laminates were prepared in the same way as in the embodiments 1 to 8.

### Examples 9 to 11

The formulas of the examples 9 to 11 are shown in Table 2. The proportions of epoxy A, epoxy B, hardener A, and promoter 2MI were the same, and a modified and surface-treated silicon dioxide filler material (Sibelco Bao-Lin, product code G2CARI) was added in proportions ranging from 121 PHR to 282.2 PHR. Acetone was also added to adjust the solid content of the resultant varnish resin composition to 75%. Then, laminates were prepared in the same way as in the examples 1 to 8.

### Comparative Examples 3 to 5

The formulas of the comparative examples 3 to 5 are detailed in Table 2. The proportions of epoxy A, epoxy B, hardener A, and promoter 2MI were the same, and surface-treated filler material A (Sibelco Bao-Lin, product code 925ARI) was added in proportions ranging from 121 PHR to 282.2 PHR. Acetone was also used to adjust the solid content of the resultant varnish resin composition to 75%. Then, laminates were prepared in the same way as in the embodiments 1 to 8.

### Results

The results are tabulated in Tables 3 and 4 and summarized as follows:
1. When the modified silicon dioxide of the present invention was used in the laminates, the coefficients of thermal expansion decreased as the proportion of the modified silicon dioxide increased, and the coefficients of thermal expansion were lower than when natural silicon dioxide and aluminum hydroxide are used.
2. When the modified silicon dioxide of the present invention was used in the laminates, the laminates exhibited good drilling workability. When the proportion of the modified silicon dioxide was 181.5 PHR (60% by weight), the drilling precision Cpk was still larger than 1.33. Moreover, the addition of the modified silicon dioxide had no effect on solder heat resistance. However, the dispersion of ingredients deteriorated when the proportion of the modified silicon dioxide increased.
3. When the modified and surface-treated silicon dioxide was used, as in the examples 9 to 11, the optimal mixing proportion of the modified silicon dioxide was raised to 181.5 PHR (60% by weight).
4. When the modified silicon dioxide of the present invention was used in the laminates, the thermal expansion coefficients of the laminates were lowered, and the drilling workability of the laminates were improved. Furthermore, the mixing proportion of the modified silicon dioxide of the present invention was increased by means of silane surface treatment.

TABLE 1
Formulas for preparing varnish resin compositions containing
modified silicon dioxide at normal temperature

| | Sample | | | | | | | | | |
|---|---|---|---|---|---|---|---|---|---|---|
| | | | | | | | | | Comparative | |
| | Example | | | | | | | | example | |
| Formulas | 1 | 2 | 3 | 4 | 5 | 6 | 7 | 8 | 1 | 2 |
| Epoxy A | 80 | 80 | 80 | 80 | 80 | 0 | 100 | 80 | 80 | 80 |
| | PHR | PHR | PHR | PHR | PHR | | PHR | PHR | PHR | PHR |
| Epoxy B | 20 | 20 | 20 | 20 | 20 | 100 | 0 | 20 | 20 | 20 |
| | PHR | PHR | PHR | PHR | PHR | PHR | | PHR | PHR | PHR |
| Hardener A | 21 | 21 | 21 | 21 | 21 | 23 | 48 | 0 | 21 | 21 |
| | PHR | PHR | PHR | PHR | PHR | PHR | PHR | | PHR | PHR |
| Hardener B | 0 | 0 | 0 | 0 | 0 | 0 | 0 | 4.47 | 0 | 0 |
| | | | | | | | | PHR | | |
| Modified | 0 | 13.4 | 80.6 | 121 | 181.5 | 123 | 148 | 104.47 | 0 | 0 |
| silicon dioxide | | PHR | PHR | PHR | PHR | PHR | PHR | PHR | | |
| Filler material A | 0 | 0 | 0 | 0 | 0 | 0 | 0 | 0 | 121 | 0 |
| | | | | | | | | | PHR | |
| Filler material B | 0 | 0 | 0 | 0 | 0 | 0 | 0 | 0 | 0 | 121 |
| | | | | | | | | | | PHR |

TABLE 2
Formulas for preparing varnish resin compositions containing
modified and surface-treated silicon dioxide

| | Sample | | | | | |
|---|---|---|---|---|---|---|
| | Embodiment | | | Comparative sample | | |
| Formulas | 9 | 10 | 11 | 3 | 4 | 5 |
| Epoxy A | 80 | 80 | 80 | 80 | 80 | 80 |
| | PHR | PHR | PHR | PHR | PHR | PHR |
| Epoxy B | 20 | 20 | 20 | 20 | 20 | 20 |
| | PHR | PHR | PHR | PHR | PHR | PHR |
| Hardener A | 21 | 21 | 21 | 21 | 21 | 21 |
| | PHR | PHR | PHR | PHR | PHR | PHR |
| Modified and surface-treated | 121 | 181.5 | 282.2 | 0 | 0 | 0 |
| silicon dioxide | PHR | PHR | PHR | | | |
| Surface-treated | 0 | 0 | 0 | 121 | 181.5 | 282.2 |
| filler material A | | | | PHR | PHR | PHR |

TABLE 3
Property evaluation results of substrates of different formulas

| | | | | | | | | | Comparative | |
|---|---|---|---|---|---|---|---|---|---|---|
| | example | | | | | | | | example | |
| Analysis item | 1 | 2 | 3 | 4 | 5 | 6 | 7 | 8 | 1 | 2 |
| Coefficient of | 290 | 245 | 178 | 145 | 120 | 148 | 140 | 155 | 156 | 167 |
| thermal expansion¹ | ppm | ppm | ppm | ppm | ppm | ppm | ppm | ppm | ppm | ppm |
| after Tg | | | | | | | | | | |
| Solder heat | >600 | >600 | >600 | >600 | >600 | >600 | >600 | 176 | >600 | 125 |
| resistance² | sec | sec | sec | sec | sec | sec | sec | sec | sec | sec |
| Drillings | 2.32 | 2.20 | 1.73 | 1.68 | 1.55 | 1.70 | 1.64 | 1.70 | 0.98 | 2.20 |
| workability³ | | | | | | | | | | |
| Dispersion of | OK | OK | OK | NG | NG | NG | NG | NG | NG | OK |
| ingredients⁴ | | | | | | | | | | |

Notes:
¹Measured by TMA (Thermomechanical Analysis), heating-up rate = 10° C./min.
²Test samples were heated in a pressure cooker (121° C., 2 atm) for 30 minutes and then submerged in a soldering pot (288° C.). The time it took for the test samples to delaminate and burst was recorded.
³Three 0.8 mm-thick laminates were stacked up and drilled as a unit so as to form 2000 bores. Bore precision was measured as Cpk values by a detecting machine.
⁴The appearance of the laminates after etching was visually examined. OK indicates that the substrate had a uniform color, and NG indicates otherwise.

TABLE 4
Properties of substrates of different formulas containing
surface-treated filler material

| | Embodiment | | | Comparative sample | | |
|---|---|---|---|---|---|---|
| Analysis item | 9 | 10 | 11 | 3 | 4 | 5 |
| Coefficient of thermal | 148 | 120 | 80 | 158 | 132 | 98 |
| expansion¹ after Tg | ppm | ppm | ppm | ppm | ppm | ppm |
| Solder heat resistance² | >600 | >600 | >600 | >600 | >600 | >600 |
| | sec | sec | sec | sec | sec | sec |
| Drilling workability³ | 1.68 | 1.57 | 0.98 | 0.98 | 0.70 | 0.43 |
| Dispersion of ingredients⁴ | OK | OK | NG | OK | OK | NG |

Notes:
¹Measured by TMA (Thermomechanical Analysis), heating-up rate = 10° C./min.
²Test samples were heated in a pressure cooker (121° C., 2 atm) for 30 minutes and then submerged in a soldering pot (288° C.). The time it took for the test samples to delaminate and burst was recorded.
³Three 0.8 mm-thick laminates were stacked up and drilled as a unit so as to form 2000 bores. Bore precision was measured as Cpk values by a detecting machine.
⁴The appearance of the laminates after etching was visually examined. OK indicates that the substrate had a uniform color, and NG indicates otherwise.

What is claimed is:

1. A thermosetting epoxy composition, for use in preparing an epoxy laminate having a low coefficient of thermal expansion, the epoxy composition comprising:
(a) a novolac epoxy, present in a proportion of 0 to 100 PHR of an entire solid content of the epoxy composition and having an epoxide equivalent weight (EEW) of about 160 to 250 g/eq;
(b) an epoxy, present in a proportion of 0 to 100 PHR of the entire solid content of the epoxy composition and having an epoxide equivalent weight of about 300 to 460 g/eq;
(c) a hardener, which is either a novolac hardener or a dicyandiamide hardener, present in a proportion of 4.47 to 48 PHR of the entire solid content of the epoxy composition; and
(d) a modified silicon dioxide, present in a proportion of 13.4 to 181.5 PHR of the entire solid content of the epoxy composition;
wherein the modified silicon dioxide contains 40% to 80% by weight of silicon dioxide and 60% to 20% by weight of an inorganic additive, the inorganic additive being one or more selected from the group consisting of aluminum oxide (Al₂O₃), boron trioxide (B₂O₃), calcium oxide (CaO), and magnesium oxide (MgO); and the modified silicon dioxide is obtained by a high-temperature (above 1000° C.) sintering process followed by a crushing process.

2. The thermosetting epoxy composition of claim 1, wherein the modified silicon dioxide is present in a proportion of 30.3 to 121 PHR of the entire solid content of the epoxy composition.

3. The thermosetting epoxy composition of claim 1, wherein the modified silicon dioxide has an average particle size of 0.1 to 20 nm.

4. The thermosetting epoxy composition of claim 1, wherein the modified silicon dioxide has a coefficient of thermal expansion of about 3 to 5 ppm/° C.
